(19) United States
(12) Patent Application Publication
(10) Pub. No.: US 2014/0355191 A1
(43) Pub. Date: Dec. 4, 2014

(54) PORTABLE ELECTRONIC DEVICE

(71) Applicant: HON HAI PRECISION INDUSTRY CO., LTD., New Taipei (TW)

(72) Inventor: CHIA-HUEI LIN, New Taipei (TW)

(73) Assignee: HON HAI PRECISION INDUSTRY CO., LTD., New Taipei (TW)

(21) Appl. No.: 14/192,881

(22) Filed: Feb. 28, 2014

(30) Foreign Application Priority Data
May 31, 2013 (TW) 102119314

(51) Int. Cl. G06F 1/16

(52) U.S. Cl. CPC G06F 1/1669
USPC 361/679.17

(57) ABSTRACT

A portable electronic device includes a main body, a keyboard, and a connecting assembly connected between the main body and the keyboard. The main body includes an electromagnetic module mounted in the main body and a button configured for powering on or off the electromagnetic module. The connecting assembly comprising a latch member configured to latch the main body and a magnet module corresponding to the electromagnetic module. The magnet module is fixed to the latch member. When the electromagnetic module is powered off, the latch member is located at a first position and locks the main body to the connecting assembly. When the electromagnetic module is powered on, the electromagnetic module pushes the magnet module and the latch member to a second position, where the latch member is unlocked from the main body for allowing detachment of the main body from the connecting assembly.

This application is related to co-pending application entitled, “PORTABLE ELECTRONIC DEVICE”, filed on ______, application Ser. No. ______, (Atty. Docket No. US51100).

### 1. FIELD

The present disclosure relates to electronic devices, and more particularly to a portable electronic device with a detachable keyboard.

### 2. BACKGROUND

A typical portable electronic device, such as a notebook computer, includes a keyboard and a display pivotably connected to the keyboard. However, the keyboard and the display are not designed to be easily detached from each other to increase diversified usage of the device.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a portable electronic device.

FIG. 2 is another view of a main body of the portable electronic device of

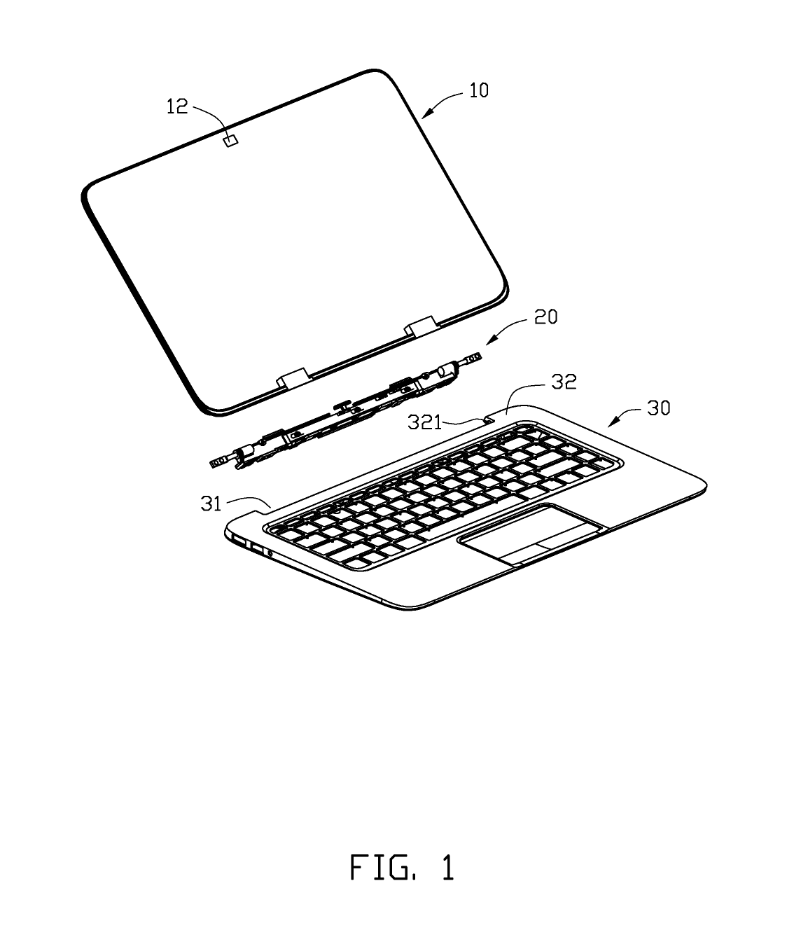

FIG. 1.

FIG. 3 is similar to FIG. 1, but viewed from another aspect.

FIG. 4 is an exploded view of a connecting assembly of the portable electronic device of FIG. 1.

FIG. 5 is similar to FIG. 4, but viewed from another aspect.

FIG. 6 illustrates a latch member of the portable electronic device of FIG. 1 being located in a first position.

FIG. 7 illustrates a latch member of the portable electronic device of FIG. 1 being located in a second position.

FIG. 8 is an assembled view of the portable electronic device of FIG. 1

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

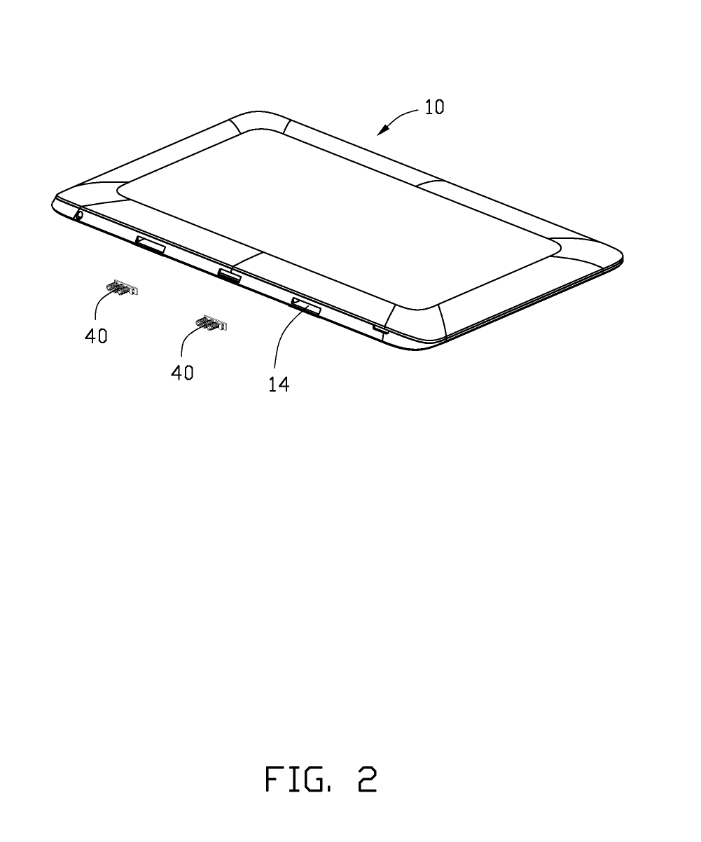

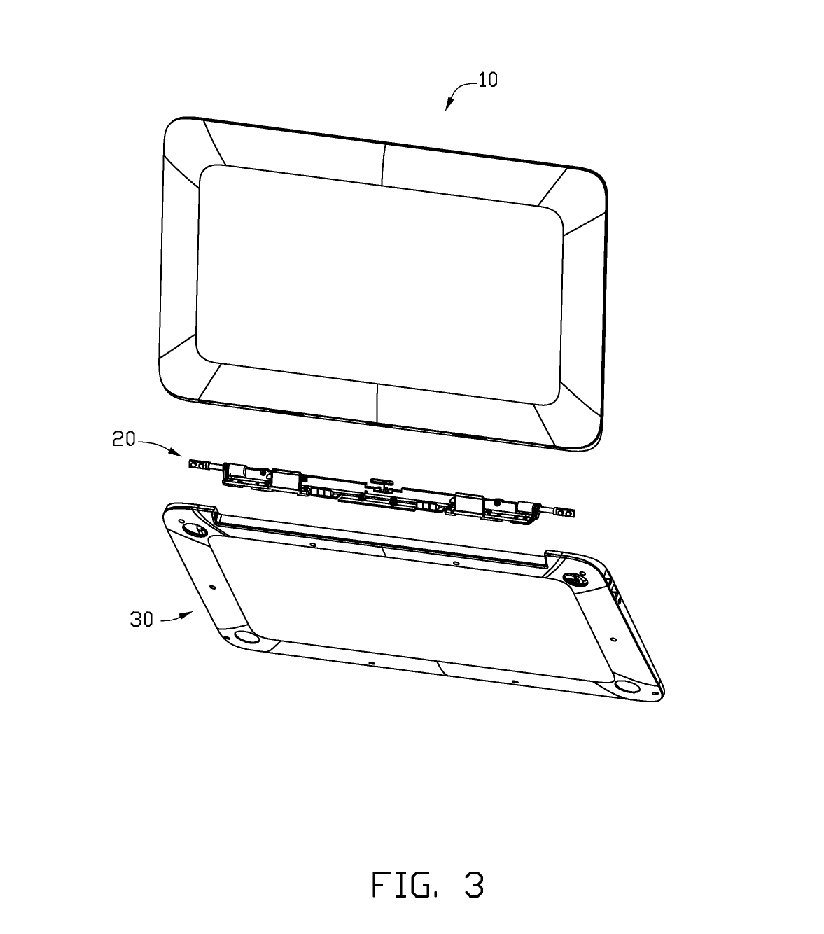

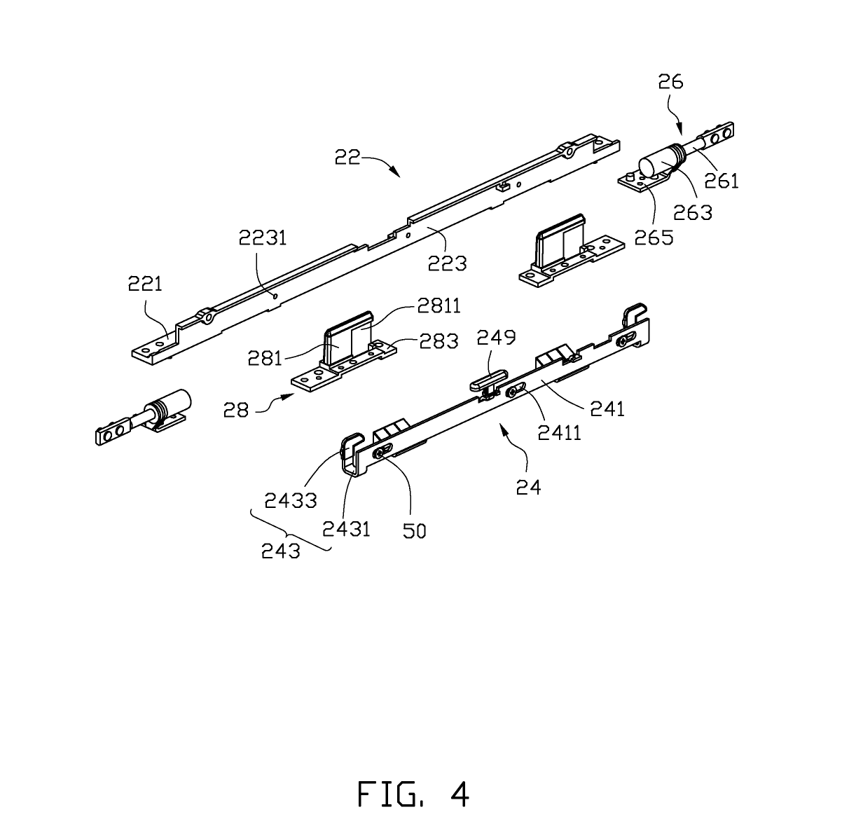

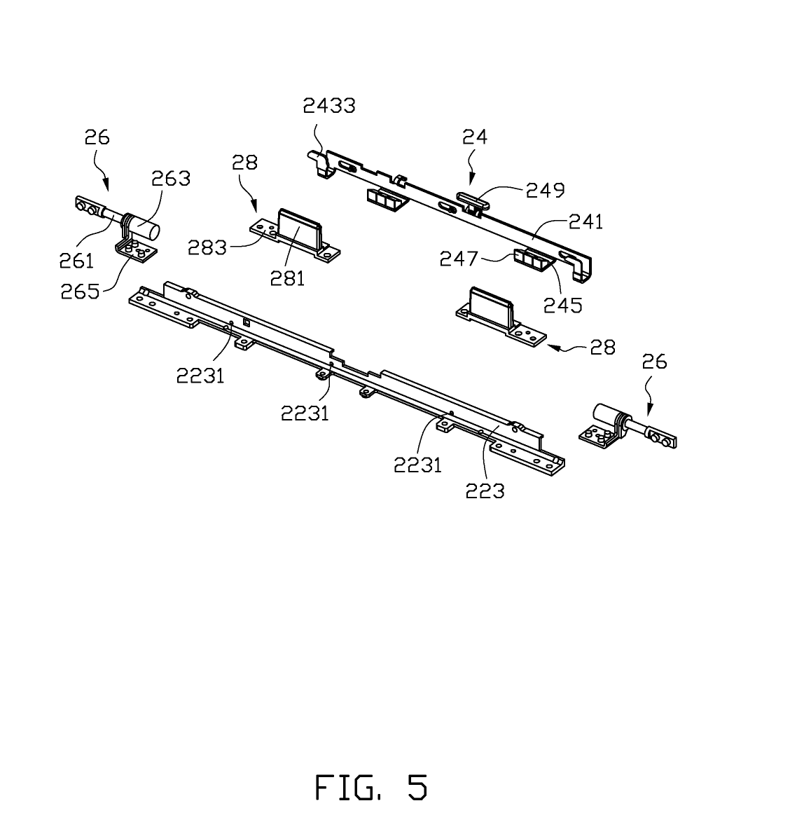

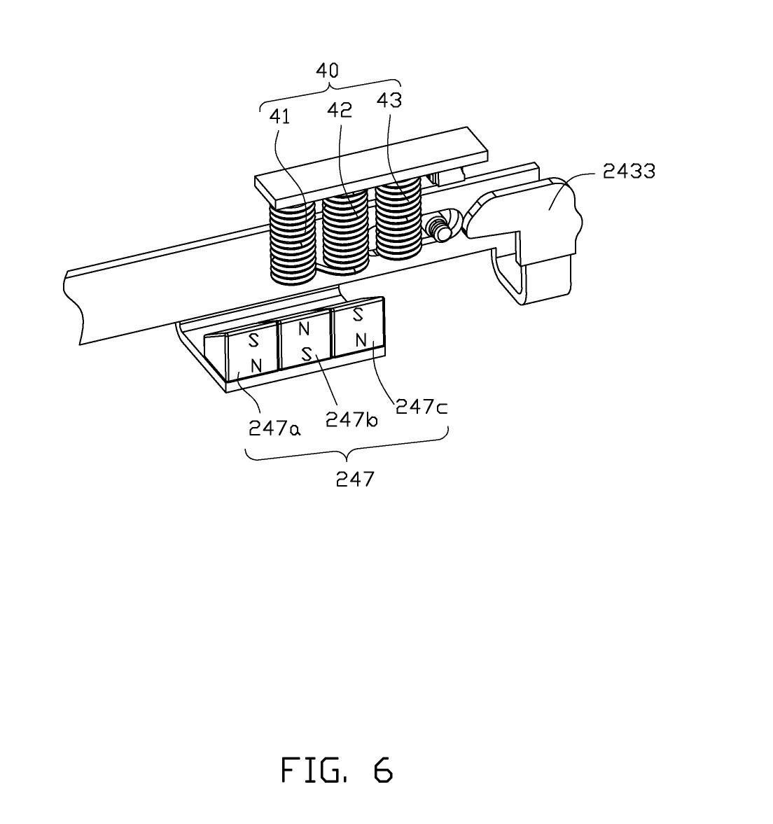

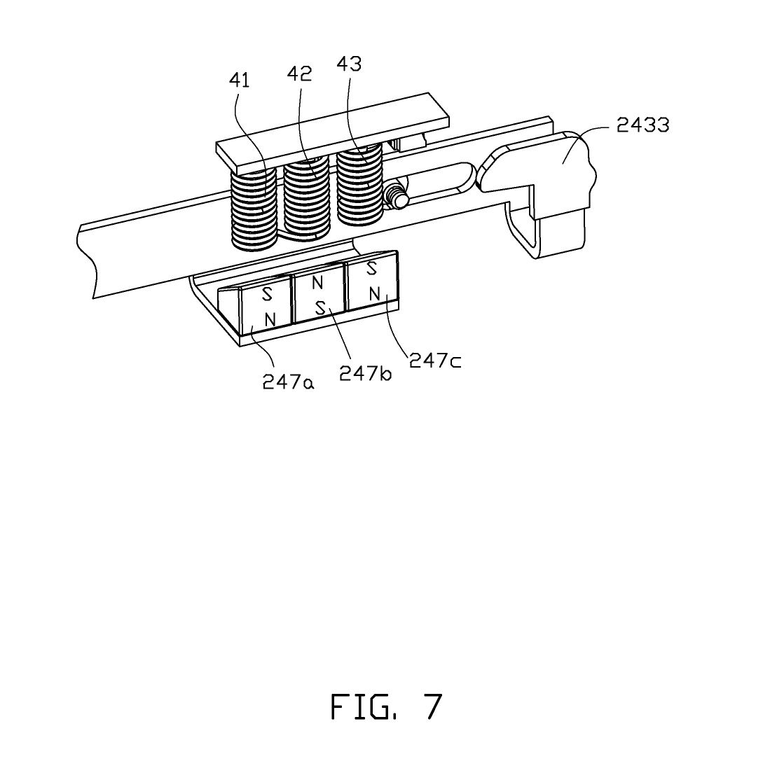

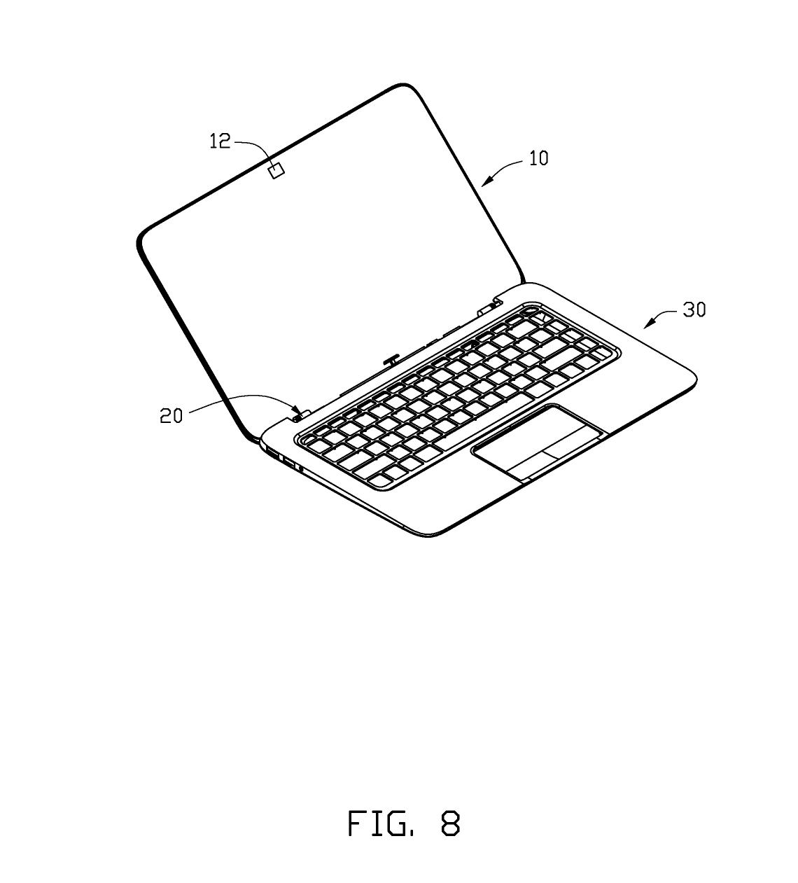

FIGS. 1 to 3 illustrate an embodiment of a portable electronic device, which includes a main body 10, a connecting assembly 20, a keyboard 30, a pair of electromagnetic modules 40. The keyboard 30 can be pivotably connected to the main body 10 by the connecting assembly 20. In one embodiment, the main body 10 includes a motherboard and a display screen. The main body 10 can be used as a tablet personal computer. A pair of mounting grooves 14 is defined in a bottom of the main body 10. The pair of electromagnetic modules 40 can be mounted in the main body 10. A button 12 is attached to the main body 12 for powering on or off the pair of electromagnetic modules 40.

The keyboard 30 includes a pair of protruding portions 32 and a hollow portion 31 located between the pair of protruding portions 32. A mounting slot 321 is defined in an inner side of each of the pair of protruding portions 32.

FIGS. 4 and 5 show the connecting assembly 20 includes a connecting shaft 22, a latch member 24, a pair of pivot mounting members 26, and a pair of mounting members 28. The connecting shaft 22 includes a base plate 223 and a flange 221 substantially perpendicularly extending from a side edge of the base plate 223. A plurality of mounting holes 2231 is defined in the base plate 223.

The latch member 24 includes a base panel 241, a pair of latch portions 243, and a pair of mounting pieces 245. The pair of latch portions 243 extends from the base panel 241 and is located at two ends of the base panel 241. The pair of mounting pieces 245 extends substantially perpendicularly from the base panel 241 and is located between the pair of latch portions 243. Each of the pair of latch portions 243 includes a connecting flange 2431 extending substantially perpendicularly from the base panel 241 and a latch piece 2433 extending substantially perpendicularly from the connecting flange 2431. The latch piece 2433 has an L shape and is substantially parallel to the base panel 241. A plurality of sliding slots 2411 is defined in the base panel 241 corresponding to the plurality of mounting holes 2231. Each sliding slot 2411 extends along a lengthways direction of the base panel 241. A magnet module 247 is mounted on each of the pair of mounting pieces 245. A handle 249 extends from a central portion of the base panel 241. The handle 249 has a T shape. A length of the latch member 24 is less than that of the connecting shaft 22.

Each of the pair of pivot mounting members 26 includes a mounting rod 261, a cylinder 263 pivotably attached to an outside of the mounting rod 261, and a mounting seat 265 attached to the cylinder 263.

Each of the pair of mounting members 28 includes a base seat 283 and a connecting piece 281 substantially perpendicularly connected to the base seat 283. The connecting piece 281 can be mounted in each of the pair of mounting grooves 14. A concave portion 2811 is defined in the connecting piece 281 and located at one side edge of the connecting piece 281.

In assembly of the connecting assembly 20, the mounting seat 265 is attached to the flange 221. The pair of pivot mounting members 26 is attached to two ends of the connecting shaft 22. The base seat 283 is attached to the connecting shaft 22 and located between the pair of pivot mounting members 26. The connecting piece 281 is substantially parallel to the base plate 223. The base panel 241 abuts on the base plate 223. The plurality of sliding slots 2411 is aligned with the plurality of mounting holes 2231. A plurality of fasteners 50 extends through the plurality of sliding slots 2411 and the plurality of mounting holes 2231. A length of the sliding slot 2411 is greater than a diameter of the fastener 50. The latch member 24 is slidably attached to the connecting shaft 22. The latch piece 2433 abuts the concave portion 2811. The connecting assembly 20 is assembled.

FIGS. 6 to 8 show that in assembly of the portable electronic device, the pair of electromagnetic modules 40 is mounted in the main body 10. The mounting rod 261 is mounted in the mounting slot 321. The connecting assembly 20 is pivotably attached to the keyboard 30 and is positioned in the hollow portion 31. The connecting piece 281 and the latch piece 2433 are positioned in the concave portion 2811 and are inserted in one of the pair of mounting grooves 14. The latch member 24 is slid along a protruding direction of the latch piece 2433. The latch piece 2433 protrudes from the concave portion 2811 and hooks at one of the pair of mounting grooves 14 for locking the main body 10 to the connecting assembly 20. The keyboard 30 is attached to the main body 10 via the connecting assembly 20. When the main body 10 is rotated relative to the keyboard 30, the mounting rod 261 is rotated in the cylinder 263. In one embodiment, the pair of electromagnetic modules 40 is mounted in the main body 10.

FIG. 6 shows that each electromagnetic module 40 includes a first electromagnetic member 41, a second electromagnetic member 42, and a third electromagnetic member 43. The magnet module 247 includes a first magnet 247a, a second magnet 247b, and a third magnet 247c. A lower end of each of the first magnet 247a and the third magnet 247c is the north pole. An upper end of each of the first magnet 247a and the third magnet 247c is the south pole. A lower end of the second magnet 247b is the south pole. An upper end of the second magnet 247b is the north pole. When the electromagnetic module 40 is powered off, the first electromagnetic member 41, the second electromagnetic member 42, and the third electromagnetic member 43 do not generate a magnetic field. The latch member 24 is in a first position relative to the electromagnetic module 40. The first electromagnetic member 41 is aligned with the second magnet 247b. The second electromagnetic member 42 is aligned with the third magnet 247c. The third electromagnetic member 43 is deviated from the magnet module 247.

FIG. 7 shows that when the electromagnetic module 40 is powered on, the first electromagnetic member 41, the second electromagnetic member 42, and the third electromagnetic member 43 generate a magnetic field. In one embodiment, a lower end of each of the first electromagnetic member 41 and the third electromagnetic member 43 is the north pole. An upper end of each of the first electromagnetic member 41 and the third electromagnetic member 43 is the south pole. A lower end of the second electromagnetic member 42 is the south pole. An upper end of the second electromagnetic member 42 is the north pole. The electromagnetic module 40 moves the magnet module 247 and the latch member 24 along a direction that is opposite to the protruding direction of the latch piece 2433. The latch member 24 is pushed to a second position (see FIG. 7) from the first position (FIG. 6). The first electromagnetic member 41 is aligned with the first magnet 247a. The second electromagnetic member 42 is aligned with the second magnet 247b. The third electromagnetic member 43 is aligned with the third magnet 247c.

When the electromagnetic module 40 is powered off and does not generate any magnetic field, the latch member 24 is maintained in the first position (see FIG. 6). The latch piece 2433 keeps hooking at one of the pair of mounting grooves 14. The connecting assembly 20 and the keyboard 30 are locked to the main body 10.

When the button 12 is operated to power on the electromagnetic module 40, the electromagnetic module 40 generates magnetic fields and pushes the magnet module 247 and the latch member 24 to move from the first position (See FIG. 6) to the second position (see FIG. 7). The latch piece 2433 is unlocked from one of the pair of mounting grooves 14. The connecting assembly 20 and the keyboard 30 can be detached from the main body 10.

In one embodiment, when the electromagnetic module 40 is powered on, the electromagnetic module 40 can push the magnet module 247 and the latch member 24 to the second position automatically. Further, the handle 249 can be pushed to move the latch member 24 between the first position and the second position manually.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A portable electronic device, comprising:
a main body comprising a mounting groove;
an electromagnetic module mounted in the main body;
a keyboard;
a connecting assembly connected between the main body and the keyboard; the connecting assembly comprising a latch member, a mounting member mounted in the mounting groove, and a magnet module corresponding to the electromagnetic module; the magnet module being fixed to the latch member; the latch member comprising a latch portion abutting the mounting member;
wherein when the electromagnetic module is powered off, the latch member is located at a first position, and the latch portion is hooked at the mounting groove, thereby locking the main body to the connecting assembly; and when the electromagnetic module is powered on, the electromagnetic module pushes the magnet module and the latch member to a second position, where the latch portion is unlocked from the mounting groove and the main body is detachable from the connecting assembly.

2. The portable electronic device of claim 1, wherein the latch member includes a base panel, the latch portion comprises a connecting flange extending substantially perpendicularly from the base panel and an L-shaped latch piece extending substantially perpendicularly from the connecting flange.

3. The portable electronic device of claim 2, wherein the connecting assembly comprises a connecting shaft, and the latch member is slidably attached to the connecting shaft.

4. The portable electronic device of claim 3, wherein a mounting hole is defined in the connecting shaft, a sliding slot is defined in the latch member, and a fastener extends through the mounting hole and the sliding slot.

5. The portable electronic device of claim 4, wherein the sliding slot extends along a sliding direction of the latch member, and a length of the sliding slot is greater than a diameter of the fastener.

6. The portable electronic device of claim 3, wherein the connecting assembly comprises a pivot mounting member, the pivot mounting member comprises a mounting rod attached to the keyboard, a cylinder pivotably attached to an outside of the mounting rod, and a mounting seat that is attached to the cylinder and secured to the connecting shaft.

7. The portable electronic device of claim 1, wherein a T-shaped handle extends from the latch member for pushing the latch member moving between the first position and the second position.

8. The portable electronic device of claim 1, wherein the mounting member comprises a base seat and a connecting piece extending substantially perpendicularly from the base seat, and the connecting piece is mounted in the mounting groove.

9. The portable electronic device of claim 8, wherein a concave portion is defined in the connecting piece; the latch portion is retracted in the concave portion when the latch member is in the second position for unlatching the main body; and the latch portion protrudes from the concave portion when the latch member is in the first position for latching the main body.

10. The portable electronic device of claim 1, wherein a button is attached to the main body for powering on or off the electromagnetic module.

11. A portable electronic device, comprising:
a main body comprising an electromagnetic module mounted in the main body and a button configured for powering on or off the electromagnetic module;
a keyboard; and
a connecting assembly connected between the main body and the keyboard; the connecting assembly comprising a latch member configured to latch the main body and a magnet module corresponding to the electromagnetic module; the magnet module being fixed to the latch member.
wherein when the electromagnetic module is powered off, the latch member is located at a first position and locks the main body to the connecting assembly; and when the electromagnetic module is powered on, the electromagnetic module pushes the magnet module and the latch member to a second position, where the latch member is unlocked from the main body for allowing detachment of the main body from the connecting assembly.

12. The portable electronic device of claim 11, wherein a mounting groove is defined in a bottom of the main body, the latch member comprises a latch portion corresponding to the mounting groove; when the latch member is in the first position, the latch portion is hooked at the mounting groove, and when the latch member is in the second position, the latch portion is unlocked from the mounting groove.

13. The portable electronic device of claim 12, wherein the latch member includes a base panel, the latch portion comprises a connecting flange extending substantially perpendicularly from the base panel and an L-shaped latch piece extending substantially perpendicularly from the connecting flange.

14. The portable electronic device of claim 12, wherein the connecting assembly comprises a connecting shaft, and the latch member is slidably attached to the connecting shaft.

15. The portable electronic device of claim 14, wherein the connecting assembly comprises a pivot mounting member, the pivot mounting member comprises a mounting rod attached to the keyboard, a cylinder pivotably attached to an outside of the mounting rod, and a mounting seat that is attached to the cylinder and secured to the connecting shaft.

16. The portable electronic device of claim 14, further comprising a mounting member mounted in the mounting groove, wherein the mounting member comprises a base seat, attached to the connecting shaft, and a connecting piece, extending substantially perpendicularly from the base seat and mounted in the mounting groove.

17. The portable electronic device of claim 16, wherein a concave portion is defined in the connecting piece; the latch portion is retracted in the concave portion when the latch member is in the second position for unlatching the main body; and the latch portion protrudes from the concave portion when the latch member is in the first position for latching the main body.

18. The portable electronic device of claim 14, wherein a mounting hole is defined in the connecting shaft, a sliding slot is defined in the latch member, and a fastener extends through the mounting hole and the sliding slot.

19. The portable electronic device of claim 18, wherein the sliding slot extends along a sliding direction of the latch member, and a length of the sliding slot is greater than a diameter of the fastener.

20. The portable electronic device of claim 11, wherein a T-shaped handle extends from the latch member for pushing the latch member moving between the first position and the second position.
